(19) United States
(12) Patent Application Publication
(10) Pub. No.: US 2018/0188797 A1
(43) Pub. Date: Jul. 5, 2018

(54) LINK POWER MANAGEMENT SCHEME BASED ON LINK'S PRIOR HISTORY

(71) Applicant: Intel Corporation, Santa Clara, CA (US)

(72) Inventors: Zhe WANG, Hillsboro, OR (US); Christopher B. WILKERSON, Portland, OR (US); Zeshan A. CHISHTI, Hillsboro, OR (US)

(21) Appl. No.: 15/394,631

(22) Filed: Dec. 29, 2016

(51) Int. Cl. G06F 1/32; G06F 13/42

(52) U.S. Cl. CPC G06F 1/3287; G06F 2213/0026; G06F 13/4282

(57) ABSTRACT

An apparatus is described. The apparatus includes power management logic circuitry to implement a power management scheme for a link in which a prior history of the link's idle time behavior is used to determine a first estimate of the link's power consumption while idle in a higher power state and determine a second estimate of the link's power consumption while idle in a lower power state. The first and second estimates are used to determine an idle time for the link at which the link is transitioned to the lower power state.

### FIELD OF INVENTION

The field of invention pertains generally to the electronic arts, and, more specifically, to a link power management scheme based on the link's prior history.

### BACKGROUND

Computer system designers, particularly with the wide scale emergence of battery powered computing systems (such as smartphones), are particularly motivated to improve the power consumption efficiency of their system. One area of particular focus is the communication links of the computing system.

### FIGURES

A better understanding of the present invention can be obtained from the following detailed description in conjunction with the following drawings, in which:

FIG. 1 shows a computing system having a multi-level system memory;

FIG. 2 shows a multi-level memory subsystem;

FIGS. 3a and 3b show different idle time probability curves;

FIGS. 4a and 4b show a process for determining when a link should be transitioned to a lower power state;

FIG. 5 shows a multi-level memory subsystem that determines when a link should be transitioned to a lower power state;

FIG. 6 shows an embodiment of a computing system.

### DETAILED DESCRIPTION

### 1.0 Multi-Level System Memory

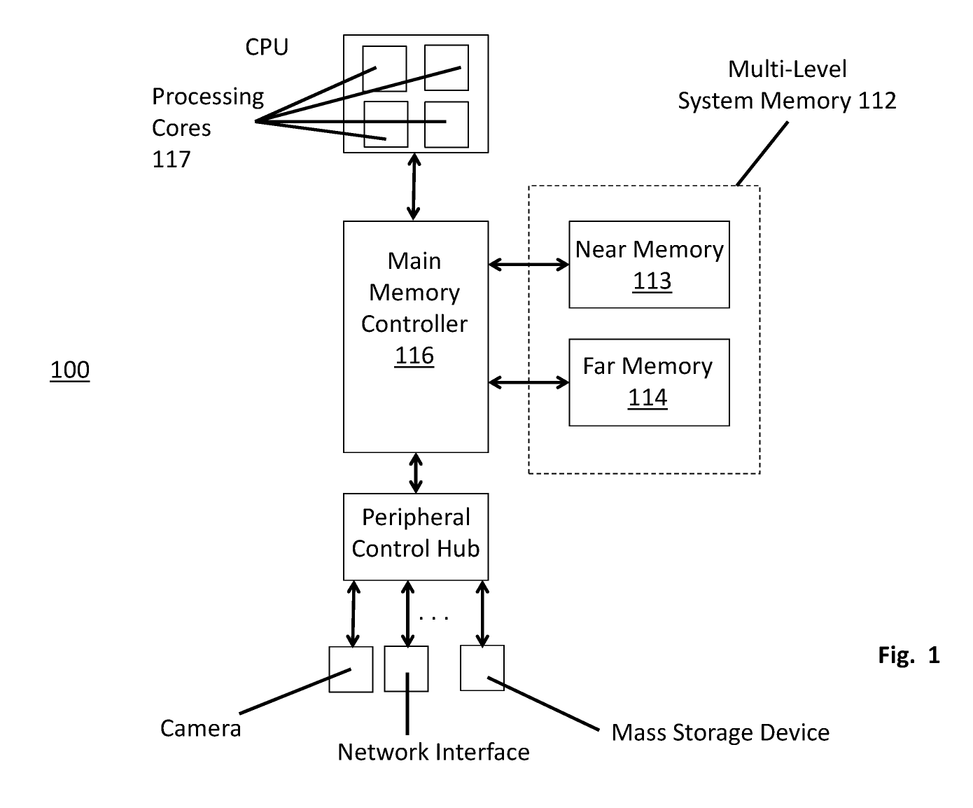

One of the ways to improve system memory performance is to have a multi-level system memory. FIG. 1 shows an embodiment of a computing system 100 having a multi-tiered or multi-level system memory 112. According to various embodiments, a smaller, faster near memory 113 may be utilized as a cache for a larger far memory 114.

The use of cache memories for computing systems is well-known. In the case where near memory 113 is used as a cache, near memory 113 is used to store an additional copy of those data items in far memory 114 that are expected to be more frequently called upon by the computing system. The near memory cache 113 has lower access times than the lower tiered far memory 114 region. By storing the more frequently called upon items in near memory 113, the system memory 112 will be observed as faster because the system will often read items that are being stored in faster near memory 113. For an implementation using a write-back technique, the copy of data items in near memory 113 may contain data that has been updated by the central processing unit (CPU), and is thus more up-to-date than the data in far memory 114. The process of writing back ‘dirty’ cache entries to far memory 114 ensures that such changes are not lost.

According to some embodiments, for example, the near memory 113 exhibits reduced access times by having a faster clock speed than the far memory 114. Here, the near memory 113 may be a faster (e.g., lower access time), volatile system memory technology (e.g., high performance dynamic random access memory (DRAM)) and/or static random access memory (SRAM) memory cells co-located with the memory controller 116. By contrast, far memory 114 may be either a volatile memory technology implemented with a slower clock speed (e.g., a DRAM component that receives a slower clock) or, e.g., a non volatile memory technology that may be slower (e.g., longer access time) than volatile/DRAM memory or whatever technology is used for near memory.

For example, far memory 114 may be comprised of an emerging non volatile random access memory technology such as, to name a few possibilities, a phase change based memory, three dimensional crosspoint memory device, or other byte addressable nonvolatile memory devices, “write-in-place” non volatile main memory devices, memory devices that use chalcogenide, single or multiple level flash memory, multi-threshold level flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc.

Such emerging non volatile random access memory technologies typically have some combination of the following: 1) higher storage densities than DRAM (e.g., by being constructed in three-dimensional (3D) circuit structures (e.g., a crosspoint 3D circuit structure)); 2) lower power consumption densities than DRAM (e.g., because they do not need refreshing); and/or, 3) access latency that is slower than DRAM yet still faster than traditional non-volatile memory technologies such as FLASH. The latter characteristic in particular permits various emerging byte addressable non volatile memory technologies to be used in a main system memory role rather than a traditional mass storage role (which is the traditional architectural location of non volatile storage).

Regardless of whether far memory 114 is composed of a volatile or non volatile memory technology, in various embodiments far memory 114 acts as a true system memory in that it supports finer grained data accesses (e.g., cache lines) rather than larger based accesses associated with traditional, non volatile mass storage (e.g., solid state drive (SSD), hard disk drive (HDD)), and/or, otherwise acts as an (e.g., byte) addressable memory that the program code being executed by processor(s) of the CPU operate out of. However, far memory 114 may be inefficient when accessed for a small number of consecutive bytes (e.g., less than 128 bytes) of data, the effect of which may be mitigated by the presence of near memory 113 operating as cache which is able to efficiently handle such requests.

Because near memory 113 acts as a cache, near memory 113 may not have formal addressing space. Rather, in some cases, far memory 114 defines the individually addressable memory space of the computing system's main memory. In various embodiments near memory 113 acts as a cache for far memory 114 rather than acting a last level CPU cache. Generally, a CPU cache is optimized for servicing CPU transactions, and will add significant penalties (such as cache snoop overhead and cache eviction flows in the case of hit) to other memory users such as Direct Memory Access (DMA)-capable devices in a Peripheral Control Hub (PCH). By contrast, a memory side cache is designed to handle accesses directed to system memory, irrespective of whether they arrive from the CPU, from the Peripheral Control Hub, or from some other device such as display controller.

In various embodiments, the memory controller 116 and/or near memory 113 may include local cache information (hereafter referred to as “Metadata”) 120 so that the memory controller 116 can determine whether a cache hit or cache miss has occurred in near memory 113 for any incoming memory request. The metadata may also be stored in near memory 113.

In the case of an incoming write request, if there is a cache hit, the memory controller 116 writes the data (e.g., a 64-byte CPU cache line) associated with the request directly over the cached version in near memory 113. Likewise, in the case of a cache miss, in an embodiment, the memory controller 116 also writes the data associated with the request into near memory 113, potentially first having fetched from far memory 114 any missing parts of the data required to make up the minimum size of data that can be marked in Metadata as being valid in near memory 113, in a technique known as ‘underfill’. However, if the entry in the near memory cache 113 that the content is to be written into has been allocated to a different system memory address and contains newer data than held in far memory 114 (ie. it is dirty), the data occupying the entry must be evicted from near memory 113 and written into far memory 114.

In the case of an incoming read request, if there is a cache hit, the memory controller 116 responds to the request by reading the version of the cache line from near memory 113 and providing it to the requestor. By contrast, if there is a cache miss, the memory controller 116 reads the requested cache line from far memory 114 and not only provides the cache line to the requestor but also writes another copy of the cache line into near memory 113. In many cases, the amount of data requested from far memory 114 and the amount of data written to near memory 113 will be larger than that requested by the incoming read request. Using a larger data size from far memory or to near memory increases the probability of a cache hit for a subsequent transaction to a nearby memory location.

Although the above discussion has described near memory 113 as acting as a memory side cache for far memory 114, in various other embodiments, some or all of near memory 113 is provided its own system memory address space and therefore can act, e.g., as a higher priority level of system memory.

In general, cache lines may be written to and/or read from near memory and/or far memory at different levels of granularity (e.g., writes and/or reads only occur at cache line granularity (and, e.g., byte addressability for writes/or reads is handled internally within the memory controller), byte granularity (e.g., true byte addressability in which the memory controller writes and/or reads only an identified one or more bytes within a cache line), or granularities in between.) Additionally, note that the size of the cache line maintained within near memory and/or far memory may be larger than the cache line size maintained by CPU level caches. Different types of near memory caching architecture are possible (e.g., direct mapped, set associative, etc.).

The physical implementation of near memory and far memory in any particular system may vary from embodiment. For example, DRAM near memory devices may be coupled to a first memory channel whereas emerging non volatile memory devices may be coupled to another memory channel. In yet other embodiments the near memory and far memory devices may communicate to the host side memory controller through a same memory channel. In the later case at least, near memory and far memory devices may be disposed on a same dual in-line memory module (DIMM) card. Alternatively or in combination, the near memory and/or far memory devices may be integrated in a same semiconductor chip package(s) as the processing cores and memory controller, or, may be integrated outside the semiconductor chip package(s).

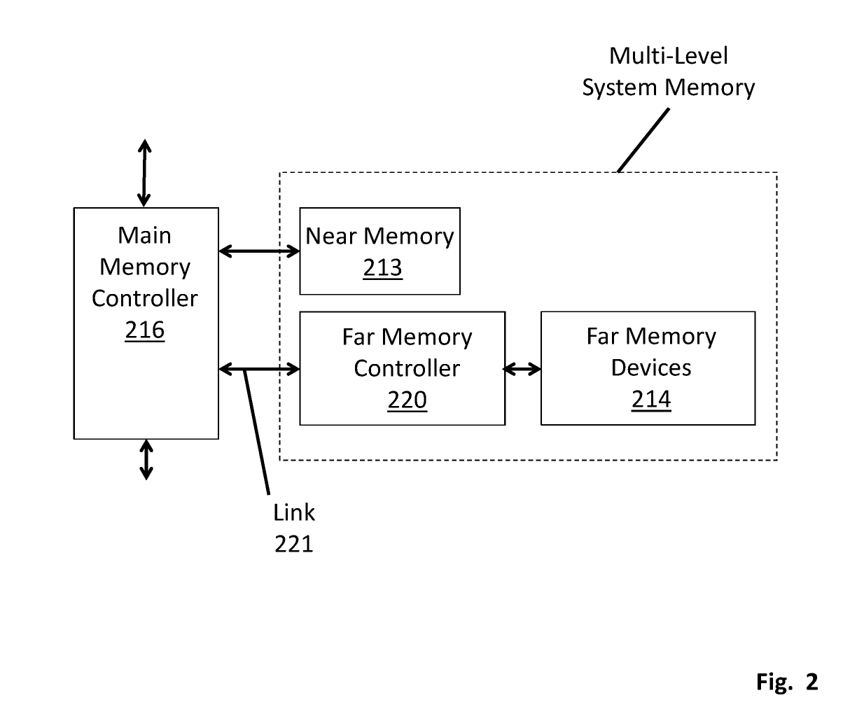

In one particular approach, far memory can be (or is) coupled to the host side memory controller through a point-to-point link 221 such as a Peripheral Component Interconnect Express (PCIe) point-to-point link having a set of specifications published by the Peripheral Component Interconnect Special Interest Group (PCI-SIG) (e.g., as found at https://pcisig.com/specifications/pciexpress/). For example, as observed in FIG. 2, the far memory devices 214 may be coupled directly to a far memory controller 220, and, a point-to-point link 221 couples the far memory controller 220 to the main host side memory controller 216.

The far memory controller 220 performs various tasks that are, e.g., specific to emerging types of non volatile included in far memory devices 214. For example, the far memory controller 220 may apply signals to the far memory devices 214 having special voltages and/or timing requirements, may manage the movement/rotation of more frequently accessed data to less frequently accessed storage cells (transparently to the system's system memory addressing organization from the perspective of the processing cores under a process known as wear leveling) and/or may identify groups of bad storage cells and prevent their future usage (also known as bad block management).

The point-to-point link 221 to the far memory controller 220 may be a computing system's primary mechanism for carrying far memory traffic to/from the host side (main) memory controller 216 and/or, the system may permit for multiple far memory controllers and corresponding far memory devices as memory expansion “plug-ins”.

In various embodiments, the memory expansion plug-in solutions may be implemented with point-to-point links (e.g., one PCIe link per plug-in). Non expanded far memory (provided as part of the basic original system) may or may not be implemented with point-to-point links (e.g., DIMM cards having near memory devices, far memory devices or a combination of near and far memory devices may be plugged into a double data rate (DDR) memory channel that emanates from the main memory controller).

### 2.0 Intelligent Link Power State Transitioning

A concern with connecting a main memory controller 216 to a far memory controller 220 as observed in FIG. 2 is the power management of the link 221. For instance, in actual implementation more than one link 221 and far memory controller 220 may emanate from a same main memory controller 216. In certain operating environments, one or more of these links may see little/no traffic and, from a power efficiency perspective, it may be advantageous to put the link into a lower, inoperative power state. Further still, in alternative or combined embodiments, one or more links (e.g., point-to-point links) may be used to couple the far memory controller 220 to the far memory devices 214. Again, certain ones of these links may also see little/no traffic and it may be advantageous from a power management perspective to put such links into lower, inoperative power state.

However, in order to realize a true power efficiency improvement, the cost of bringing any sleeping link back into an operative power state in response to the link being presented with new traffic after it has been put to sleep needs to be accounted for. Here, the power consumed bringing a link back to an operative state from a sleep mode can be non negligible.

For example, if a link is put to sleep and then shortly after being put to sleep is awoken to handle new traffic, because of the power consumed waking the link, more overall power may be consumed than if the link had simply remained in the higher power state. On the contrary, however, if the link remains in a sleep state for an extended period of time before being woken to handle new traffic, true power savings should be realized. That is, because of the lower power consumption of the sleep state, more power is saved during an extended sleep state than consumed during the re-awakening process.

Therefore, if an accurate prediction could be made as to how soon a link is expected to receive new traffic from its present idle state (or said another way, how long a link idle time is expected to last), a more informed power state transition decision could be made that truly results in improved power efficiency. More specifically, if the link is expected to receive new traffic relatively soon (short expected link idle time), the link should remain in its present higher power state. However, if the link is only expected to receive new traffic in the more distant future (long expected link idle time), the link should be placed into a lower power state.

One industry standard, referred to as Advanced Configuration and Power Interface (ACPI) standard (e.g., Advanced Configuration and Power Interface (ACPI) specification, version 6.1, published by the Unified Extensible Firmware Interface Forum (UEFI), Jan. 2016), defines a highest power state (P0). The P0 state is the only power state at which a power managed component is operable. A hierarchy of multiple performance states are defined to operate out of the P0 power state where increasing performance state in the hierarchy corresponds to higher performance/utility by the component and correspondingly higher power consumption by the component.

In the reverse direction, ACPI also defines lower power states (P1, P2, etc.) in which the component is non operable and each lower power state corresponds to less power consumption by the component and a longer time delay bringing the component back to the operable P0 state. For example, the P2 state consumes less power than the P1 state and a longer amount of time will be expended waiting for the component to reach the P0 state from the P2 state than from the P1 state. Commonly, one or more of the low power states is defined to include removal of the power supply voltage and/or removal of one or more clocks that the component operates from.

The power states defined for a PCIe link approximately correspond to the ACPI format. Specifically, for a PCIe link, there is a highest power P0 state in which the link is operable. There are also two lower power states P1 and P2. When dropping a link from the P0 state to the P1 state the link becomes inoperable. When dropping the link from the P1 state to the P2 state the link consumes even less power than in the P1 state but takes longer to transition back to the P0 state upon a wake up event than from the P1 state. Additionally, the transitioning of the link from the P1 state back to the PO state consumes a first certain amount of non negligible power and transitioning the link back to the P0 state from the P2 state consumes a second (typically larger) amount of non negligible power.

A such, when a decision is being made to drop a link from the P0 state to the P1 state it would be pertinent to know: 1) how much power is consumed by the link in the P0 state during idle time; 2) how much power is consumed by the link in the P1 state during idle time; and, 3) how much power is consumed by the link transitioning from the P1 state back to the P0 state. With this knowledge and an accurate prediction of how long the link is expected to remain idle before it receives new traffic, a calculation can be made that compares the power of 1) above to the power of 2) and 3) above.

If the power of 1) above is less than the power of 2) and 3) above, which should be the case if the link is expected to receive new traffic relatively soon, then the link should remain in the P0 state and not transitioned into the P1 state. By contrast, if the power of 1) above is more than the power of 2) and 3) above, which should be the case if the link is expected to receive new traffic in the distant future, then the link should be transitioned into the P1 state rather than remain in the P0 state. A substantially similar analysis can also take place when deciding whether or not to drop the link down to a P2 state from a P1 state.

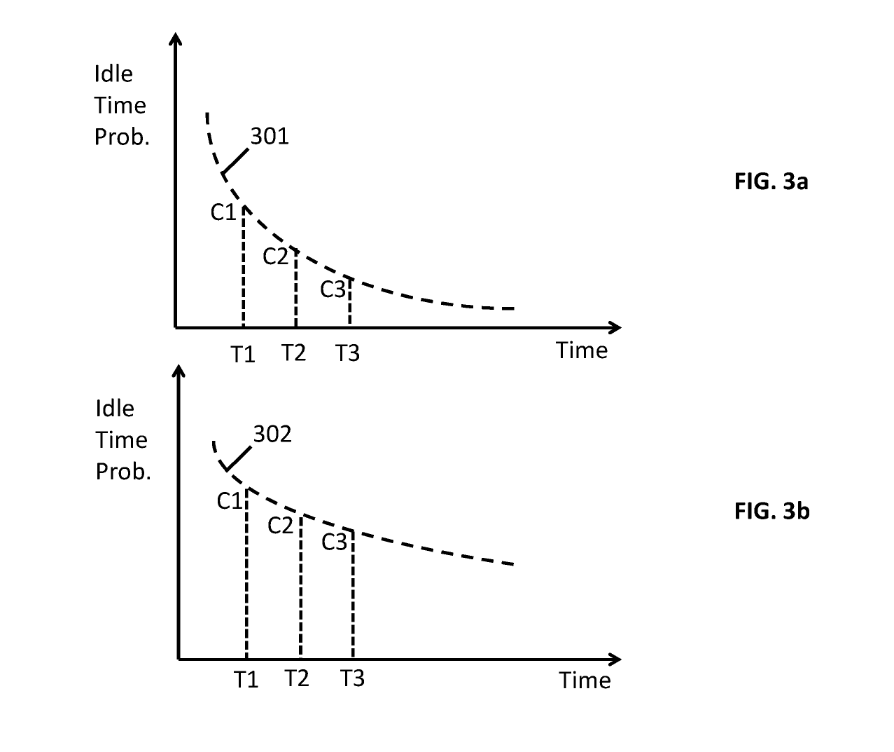

FIGS. 3a and 3b pertain to an approach for estimating the time that a link will remain idle from its current state. In an embodiment, an estimate as to how long a link will remain idle from its current state is based on collected information that tracks link idle time over previous link history. Specifically, three counters C1, C2 and C3 correspond to three different observed link idle times. Here, count C1 maintains a count of how many times a link idle time period has been observed to extend beyond a time T1; count C2 maintains a count of how many times a link idle time period has been observed to extend beyond a time T2; and, count C3 maintains a count of how many times a link idle time period has been observed to extend beyond a time T3. The counters can be implemented with respective registers associated with link logic circuitry that monitor, for each of a number of observed idle times of a link, how long in time each idle period lasted.

Note that because T1<T2<T3 then C1>C2>C3. That is, any idle time which has been observed to extend beyond time T3 (and therefore increment C3) must also have extended beyond time T1 and T2 (and therefore would have also incremented C1 and C2). Likewise, any idle time which has been observed to extend beyond time T2 (and therefore increment C2) must also have extended beyond time T1 (and therefore would have also incremented C1).

FIG. 3a shows first exemplary C1, C2 and C3 count totals in which fairly short idle time periods have been observed. Here, because fairly short idle time periods have been observed C1>>C2>>C3 which corresponds to a fairly steep drop-off in estimated idle time probability. That is, curve 301 represents, along the vertical axis, the probability that the link will demonstrate a particular idle time as measured along the horizontal, time axis.

By contrast, FIG. 3b shows second exemplary C1, C2 and C3 count totals in which longer idle time periods have consistently been observed. Here, because fairly long idle time periods have been observed, C1, C2 and C3 are more comparable to one another than in FIG. 3a which corresponds to a fairly shallow drop-off in estimated idle time probability 302.

In various embodiments, a specific link is allowed to operate for a period of time until a threshold number of samples have been taken (which, e.g., corresponds to a minimum threshold have been reached in the count values of one or more of C1, C2 and C3). Once a threshold number of samples have been taken, decisions as to whether a link should be dropped down to a lower power state in response to being idle are permitted to be made based on the count values of C1 and C2 (for a decision to drop from P0 to P1) and count values of C2 and C3 (for a decision to drop from P1 to P2).

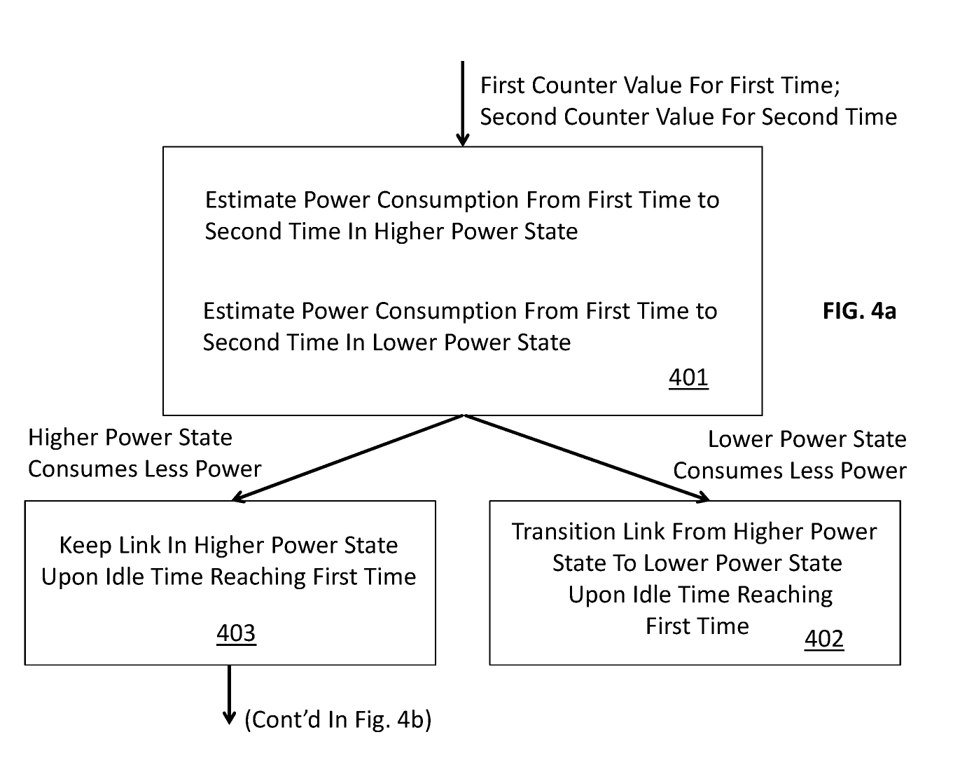

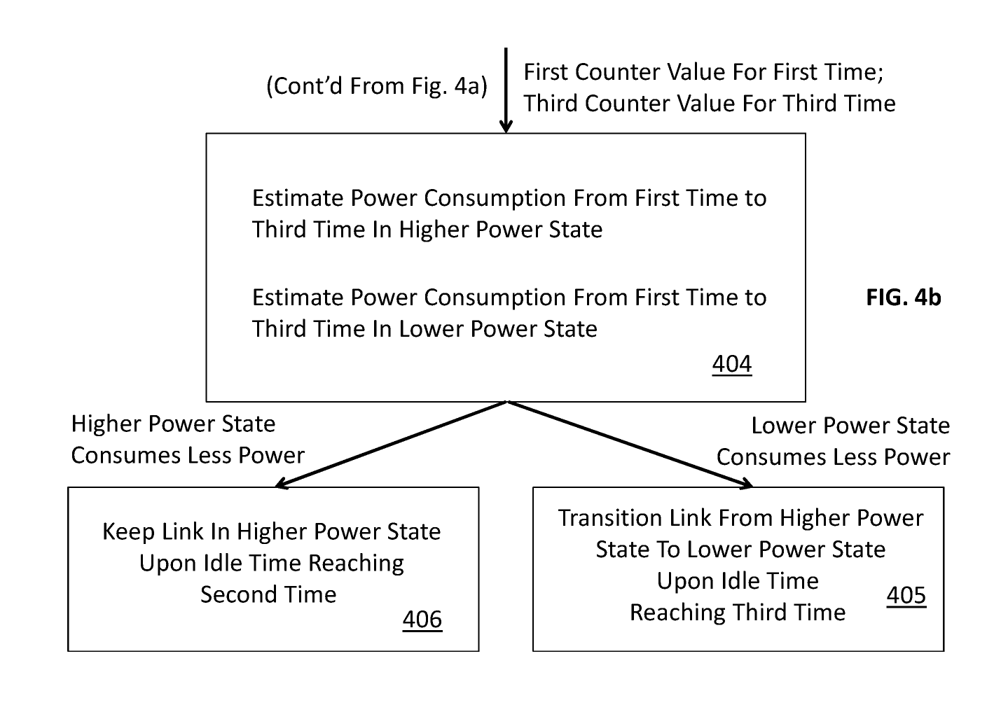

Referring to FIG. 4, in an embodiment, when making a decision whether to drop down to a lower power state from a current power state, a pair of equations are executed that employ the counter values to factor expected idle time probabilities into the equations 401. A first of the equations expresses how much power the link is expected to consume, from a first link idle time to a second link idle time, if it does not switch to a lower power state from its current power state. A second of the equations expresses how much power the link is expected to consume, from the first time to the second time, if instead the link switches to its next lower power state. Here, the first time may correspond to T1 in FIGS. 3a and 3b and the second time may correspond to T2 in FIGS. 3a and 3b. Additionally, C1 may be used by the equations as the probability of the link idle time reaching T1 and C2 may be used by the equations as the probability of the link idle time reaching T2.

In an embodiment, the first pair of equations are concurrently executed and if the second equation generates a lower number than the first equation, then the expectation is that the link will consume less power if it drops down to the lower power state upon the next observed idle time to reach T1 rather than remain in its current state. As such, if an observed idle time reaches T1, the link is lowered to the lower power state 402. By contrast, if the first equation generates a smaller number than the second equation, then the expectation is that the link will consume less power if it does not drop down to a lower power state in response to the next observed idle time to reach T1. As such, the link is not dropped down to its next lower power state upon the next observed idle time to reach T1 402.

Additionally, with the decision being made not to drop the link power state down upon the next observed idle time to reach T1 402, as observed in FIG. 4b, a second pair of equations are next executed 404 to determine if the link should be transitioned to the lower power state in response to the next observed idle time to reach T2. Here, with the decision having been made not to transition the power state to its next lower state upon the next observed idle time to reach T1 403, the observed behavior of the link demonstrates a more rapid roll-off idle time probability similar to that observed in FIG. 3a.

If the roll-off is extremely rapid it may be more power efficient to still keep the link in its present state even in response to a next observed idle time that reaches more distant time T2. By contrast, if the roll-off, though pronounced, is not extremely rapid, it may be more power efficient to drop the link down to the lower power state upon the next idle time to reach T2 rather than keep the link in its current state.

Execution of the second pair of equations are used to make this determination. A first equation of the second pair of equations expresses how much power the link is expected to consume from the first link idle time T1 to a third link idle time T3 if it does not switch to the lower power state from its current power state. A second equation of the second pair of equations expresses how much power the link is expected to consume from the first time to the third time if instead the link switches to the lower power state. Here, the first time may correspond to T1 in FIGS. 3a and 3b and the third time may correspond to T3 in FIGS. 3a and 3b. Additionally, C1 may be used by the equations as the probability of the link idle time reaching T1 and C3 may be used by the equations as the probability of the link idle time reaching T3.

As such, if the second equation of the second pair of equations generates a lower number than the first equation of the second pair of equations, then the expectation is that the link will consume less power if it drops down to the lower power state upon the next observed idle time to reach T2 rather than remain in its current state. As such, the link is dropped down 405 to the lower state in response to the next observed idle time to reach T2.

By contrast, if the first equation of the second pair of equations generates a smaller number than the second equation of the second pair of equations, then, the expectation is that the link will still consume less power if it does not drop down to the lower power state upon the next observed idle time to expand out as far as T2. Thus, in this case, the link will not be dropped down to the lower power state 406 even if an idle time is observed to expand to T2.

Thus, in summary, T1 and T2 represent “candidate” observed idle time lengths at which the link may drop down to a lower state depending on the prior history of observed link behavior. If based on the execution of the first pair of equations 401 the prior history indicates that, if an observed idle time reaches T1, the link will nevertheless consume less power by remaining within its present power state, then, a next analysis is performed (execution of the second pair of equations 404) to be see if the prior history indicates that, if an observed idle time reaches T2, the link should be dropped down to the lower state or remain in its present state.

Again, to the extent the prior history suggests that expected idle time should not extend very far out in time, then, the link will be less prone to drop down to a lower power state. By contrast, if the prior history suggests the expected idle time can extend for a longer period of time, the link will be more prone to drop down to a lower power state.

In an embodiment, the first pair of equations are as follows:

(K1*(C1−C2)*T_AVG)+(K1*C2*(T2−T1)) Eqn. 1

(K2*(C1−C2)*T_AVG)+(K2*C2*(T2−T1))+(K3*(C1−C2)) Eqn. 2.

Here, again, Eqn. 1 represents the amount of power consumed by the link if it does not drop down to its next lower power state in response to an observed idle time reaching T1 and Eqn. 2 represents the amount of power consumed by the link if does drop down to its next lower power state in response to an observed idle time reaching T2.

The first term in Eqn. 1, K1*(C1−C2)*T_AVG, corresponds to the power consumed by the link in its current power state for an idle time that extends beyond time T1 but that does not reach time T2 factored by the probability that an idle time will reach T1 but not reach T2. The K1 term is a metric that describes the power consumption of the link in its current power state while the link is idle. The C1−C2 term essentially articulates the probability that an observed idle time will reach T1 but will not reach T2. The T_AVG term is a metric that approximates the expected idle time beyond T1 for an idle time that extends beyond T1 but does not reach T2. In an embodiment, T_AVG is set equal to (T2−T1)/3 which approximately assumes an exponential roll-off or decay of observed idle time probability with increasing idle time.

The second term of Eqn. 1, K1*C2*(T2−T1), corresponds to the power consumed by the link in its current power state for an idle period that reaches a time period of T2 factored by the probability that an idle time will reach T2. Here, again, K1 is the power metric of the current power state. C2 represents the probability that an observed idle time will reach T2. T2−T1 is the time length of such an idle time beyond T1.

In the case of observed behavior that is similar to FIG. 3a, the second term will be small which will have the effect of reducing the power consumed by the link in its current state. By contrast, in the case of observed behavior that is similar to FIG. 3b, the second term will be large which will have the effect of increasing the power consumed by the link in its current state. The former will weigh in favor of keeping the link in its current state while the later will weigh in favor of dropping the link down to its next lowest power state.

Comparing Eqn. 1 and Eqn. 2 note that the first two terms of Eqn. 2 are the same as Eqn. 1 but employ a different power metric K2. Here, K2<K1 to reflect that the link will consume less power for idle periods from T1 to T2 in the lower power state. The last term in Eqn. 2, K3*(C1−C2) corresponds to the power consumed transitioning the link back to the P0 state. Here, K3 corresponds to another power metric that reflects the inherent power consumption of the transition from the next lower power state to the P0 state and C1−C2 represents a relative probability that such a transition will actually occur.

With respect to the C1−C2 probability term, if C1=C2 then the idle time probability curve is an extreme version of the probability function of FIG. 3b in which there is (theoretically) zero probability that the link will be transitioned back to the P0 state (theoretically, curve 302 never reaches the horizontal axis). By contrast, if C1>>C2, then the idle time probability curve is more like FIG. 3a and the probability that the link will transition back to the P0 state is much greater. Thus, with the third term representing the penalty of moving the link down to a next lower power state, the third term becomes less of a penalty the greater the expected idle time and more of a penalty the shorted the expected idle time.

In a same embodiment, the second pair of equations 404 take the form of

(K1*(C2−C3)*T_AVG)+(K1*C3*(T3−T2)) Eqn. 3

(K2*(C2−C3)*T_AVG)+(K2*C3*(T3−T2))+(K3*(C2−C3)) Eqn. 4.

which have the same format as Eqns. 1 and 2, but, instead of analyzing at T1/C2 while looking forward to T2/C2 (as with Eqns. 1 and 2), Eqns. 3 and 4 analyze at T2/C2 looking forward to T3/C3.

Additional “chains” of equation pairs can be executed for additional candidate idle time periods that, if observed, the link power state can have the option of transitioning to a next lower power state (e.g., T3, T4, T5, etc.). So doing gives the link power management function a wider spread of link transition options in time space.

Further still, analysis as described above can be performed for every power state (except the lowest power state). Here, the equations for the analysis to be performed at a lower power state will include lower corresponding power metrics. For example, if the above analysis corresponds to the analysis for when the link is in the P0 state and may drop down to the P1 power state, Eqn. 1 for the analysis to be performed when the link is in the P1 power state and may drop down to the P2 power state will have K2 as the power metric and Eqn. 2 will have a first other power metric (K4) that represents inherent link power consumption in the P2 state and a second other power metric (K5) that represents power consumption transitioning back to the P0 state from the P2 state. Here K2>K4 and K3>K5.

Note that the selected idle time for transition from the candidate idle times can change as the observed prior history changes. For example, in one embodiment, a number of idle times are observed (e.g., 100,000) and upon the threshold number of idle time observations being reached, a candidate idle time is selected from the available candidate idle times for each power state in the link. After the candidate idle times are selected, the observation activities restart and then complete after a next 100,000 observed idle times are observed. A fresh set of candidate idle times are then selected for each power state from the count values of the most recent observations. Thus the system continually observes link idle time behavior and can adjust its power state transition idle time settings in response to changes in idle time behavior.

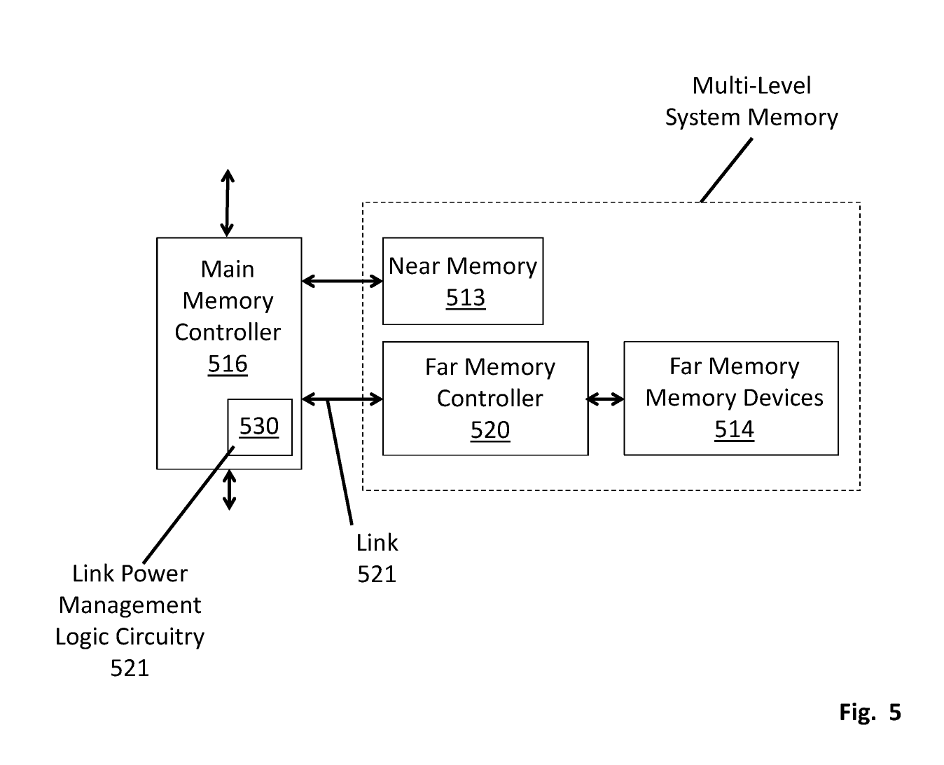

FIG. 5 shows a memory subsystem for, e.g., a multi-level system memory that includes a link 521 that emanates from a main memory controller 516. As depicted in FIG. 5 the main memory controller 516 may include link power management logic circuitry 530 that includes logic circuitry to observe a number of idle periods of the link and measure how many such idle time periods reach a plurality of elapsed time values (e.g., T1, T2, T3, etc.). Here, as discussed above, the link power management logic circuitry 530 may include counters that track count values for each of the elapsed time values. The link power management logic circuitry 530 may then execute the processing described above with respect to FIGS. 4a and 4b to determine an appropriate elapsed idle time at which the link should be dropped to a lower power state.

The link power management logic circuitry 530 may be implemented with dedicated hardware circuitry such as hardwired logic circuitry and/or programmable logic circuitry (e.g., field programmable gate array (FPGA), programmable logic device (PLD), programmable logic array (PLA)). Alternatively or in combination with dedicated hardware circuitry, the link power management logic circuitry 530 may be implemented with hardware circuitry that executes program code configured to perform some or all of the methods of the link power management logic circuitry 530 (e.g., embedded processor, embedded controller, etc.).

Further still, some or all of the methods described above as being performed by the link power management logic circuitry 530 may instead be performed by higher level software or system level firmware, such as power management software that is integrated into or operates with an operating system that executes on a general purpose processing core (e.g., in systems where link power management is performed, e.g., by system power management software). Further still, such methods may be performed by a cooperative combination of software, firmware and the link power management logic circuitry 530.

Additionally, although the link power management logic circuitry 530 is depicted as being integrated into main memory controller 516 for controlling the power management of link 521, in other implementations such link power management logic circuitry 530 may be integrated into the far memory controller 520. Furthermore, similar link power management logic circuitry 530 may be integrated into far memory controller 520 to control the power management of any links that emanate from the far memory controller 520 to the far memory devices 514.

Although embodiments described above have been directed to a link that is part of a main memory implementation, is still other implementations the link may be associated with some other system component (e.g., network interface, processor to processor link, processor to memory controller link, graphics processor to memory/memory controller link, etc.).

Although embodiments above been directed to a PCIe link it is pertinent to point out that other links may also use the teachings described herein (e.g., an ultra path interconnect (UPI) or quick path interconnect (QPI) link from Intel corporation of Santa Clara, Calif., an Ethernet link, etc.).

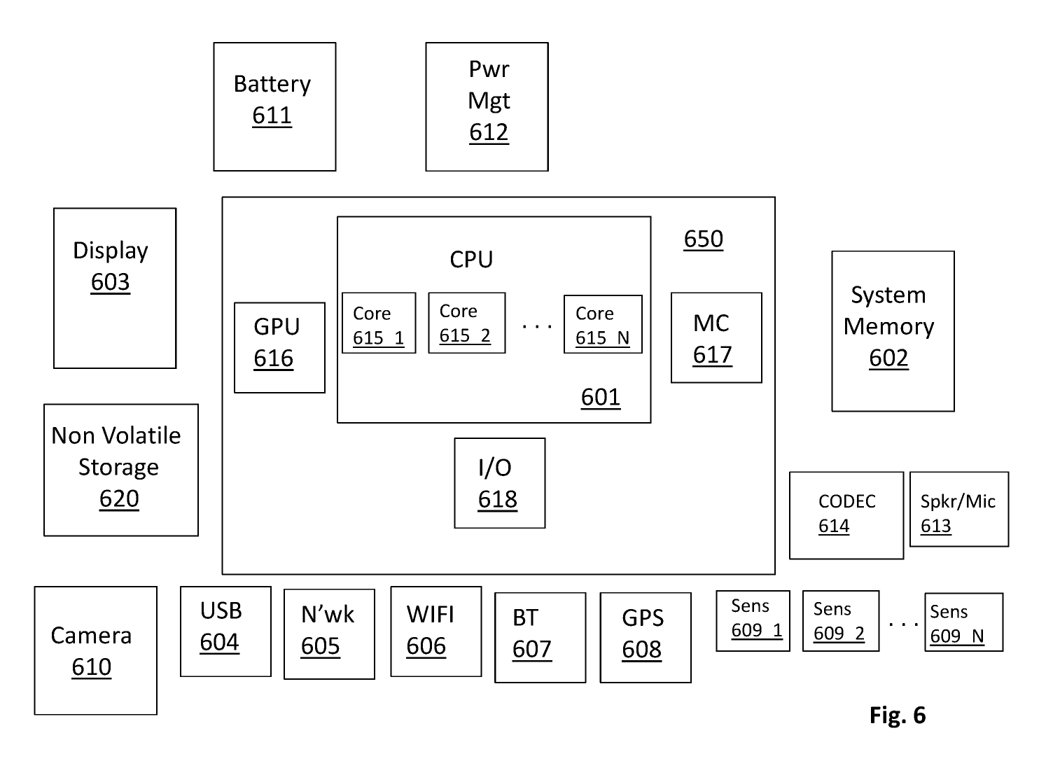

FIG. 6 shows a depiction of an exemplary computing system 600 such as a personal computing system (e.g., desktop or laptop) or a mobile or handheld computing system such as a tablet device or smartphone, or, a larger computing system such as a server computing system. As observed in FIG. 6, the basic computing system may include a central processing unit 601 (which may include, e.g., a plurality of general purpose processing cores and a main memory controller disposed on an applications processor or multi-core processor), system memory 602, a display 603 (e.g., touchscreen, flat-panel), a local wired point-to-point link (e.g., USB) interface 604, various network I/O functions 605 (such as an Ethernet interface and/or cellular modem subsystem), a wireless local area network (e.g., WiFi) interface 606, a wireless point-to-point link (e.g., Bluetooth) interface 607 and a Global Positioning System interface 608, various sensors 609_1 through 609_N (e.g., one or more of a gyroscope, an accelerometer, a magnetometer, a temperature sensor, a pressure sensor, a humidity sensor, etc.), a camera 610, a battery 611, a power management control unit 612, a speaker and microphone 613 and an audio coder/decoder 614.

An applications processor or multi-core processor 650 may include one or more general purpose processing cores 615 within its CPU 601, one or more graphical processing units 616, a memory management function 617 (e.g., a memory controller) and an I/O control function 618. The general purpose processing cores 615 typically execute the operating system and application software of the computing system. The graphics processing units 616 typically execute graphics intensive functions to, e.g., generate graphics information that is presented on the display 603. The memory control function 617 interfaces with the system memory 602. The system memory 602 may be a multi-level system memory.

The system may include a link having power management that determines when a link should be placed into a lower power state based on observed prior idle time behavior of the link. They link may, but need not, be a component in a multi-level system memory.

Each of the touchscreen display 603, the communication interfaces 604-607, the GPS interface 608, the sensors 609, the camera 610, and the speaker/microphone codec 613, 614 all can be viewed as various forms of I/O (input and/or output) relative to the overall computing system including, where appropriate, an integrated peripheral device as well (e.g., the camera 610). Depending on implementation, various ones of these I/O components may be integrated on the applications processor/multi-core processor 650 or may be located off the die or outside the package of the applications processor/multi-core processor 650. The mass storage of the computing system may be implemented with non volatile storage 620 which may be coupled to the I/O controller 618 (which may also be referred to as a peripheral control hub).

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of software or instruction programmed computer components or custom hardware components, such as application specific integrated circuits (ASIC), programmable logic devices (PLD), digital signal processors (DSP), or field programmable gate array (FPGA).

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The discussions above have described an apparatus that includes power management logic circuitry or power management logic circuitry and power management program code to implement a power management scheme for a link in which a prior history of the link's idle time behavior is used to determine a first estimate of the link's power consumption while idle in a higher power state and determine a second estimate of the link's power consumption while idle in a lower power state. The first and second estimates are used to determine an idle time for the link at which the link is transitioned to the lower power state.

The discussions above have described the apparatus where the power management logic circuitry is to analyze multiple idle time candidates at which the link is transition-able from said higher power state to a said lower power state. Additionally, the following may be reveal-able by the power management logic circuitry's implementation of the power management scheme: a) a first idle time when keeping the link in the higher power state is more power efficient than transitioning the link to the lower power state even though the link is idle; and, b) a second idle time when transitioning the link from the higher power state to the lower power state is more power efficient than keeping the link in the higher power state because the prior history indicates that the idle time is expected to be sufficiently extensive.

The discussions above have described the apparatus where the second estimate includes an estimate of power consumption of waking the link. The discussions above have described the apparatus where the link is a PCIe link. The discussions above have described the apparatus where the link is a component in a multi-level system memory. The discussions above have described the apparatus where the power management logic circuitry includes counters, each counter of the counters to count a respective observed idle time of said prior history.

The discussions above have described the apparatus where, if a comparison of the first and second estimates reveals that the link is expected to consume less power if the link remains in the higher power state than if the link were to transition to the lower power state at a first link idle time, the power management logic is to determine a third estimate of the link's power consumption while idle in the higher power state for a second idle time that is longer than the first idle time and determine a fourth estimate of the link's power consumption while idle in the lower power state for the second idle time. The discussions above have described the apparatus within a computing system comprising a plurality of processing cores, a memory controller.

The discussions above have described a method that includes tracking a prior history of a link's idle time behavior; determining a first estimate of the link's power consumption while idle in a higher power state; determining a second estimate of the link's power consumption while idle in a lower power state; and, using the first and second estimates to determine an idle time for the link at which the link is transitioned to the lower power state.

The method can include analyzing multiple idle time candidates at which the link is transition-able from the higher power state to the lower power state. The tracking can further include maintaining counters for each of the multiple candidate idle times.

The method can be performed where the second estimate includes an estimate of power consumption of waking the link. The method can be performed where the link is a component in a multi-level system memory. The method can further include comparing the first and second estimates and if the comparison reveals that the link is expected to consume less power if the link remains in the higher power state than if the link were to transition to the lower power state at a first link idle time, then, determining a third estimate of the link's power consumption while idle in the higher power state for a second idle time that is longer than the first idle time and determining a fourth estimate of the link's power consumption while idle in the lower power state for the second idle time.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising;
power management logic circuitry to implement a power management scheme for a link in which a prior history of said link's idle time behavior is used to determine a first estimate of said link's power consumption while idle in a higher power state and determine a second estimate of said link's power consumption while idle in a lower power state, and where said first and second estimates are used to determine an idle time for said link at which said link is transitioned to said lower power state.

2. The apparatus of claim 1 wherein said power management logic circuitry is to analyze multiple idle time candidates at which said link is transition-able from said higher power state to a said lower power state.

3. The apparatus of claim 2 wherein the following is reveal-able by said power management logic circuitry's implementation of said power management scheme:
a) a first idle time when keeping said link in said higher power state is more power efficient than transitioning said link to said lower power state even though said link is idle; and,
b) a second idle time when transitioning said link from said higher power state to said lower power state is more power efficient than keeping said link in said higher power state because said prior history indicates that said idle time is expected to be sufficiently extensive.

4. The apparatus of claim 1 wherein said second estimate includes an estimate of power consumption of waking said link.

5. The apparatus of claim 1 wherein said link is a PCIe link.

6. The apparatus of claim 1 wherein said link is a component in a multi-level system memory.

7. The apparatus of claim 1 wherein said power management logic circuitry includes counters, each counter of the counters to count a respective observed idle time of said prior history.

8. The apparatus of claim 1 wherein, if a comparison of said first and second estimates reveals that said link is expected to consume less power if said link remains in said higher power state than if said link were to transition to said lower power state at a first link idle time, said power management logic is to:
determine a third estimate of said link's power consumption while idle in said higher power state for a second idle time that is longer than said first idle time and determine a fourth estimate of said link's power consumption while idle in said lower power state for said second idle time.

9. The apparatus of claim 1 further comprising a computing system comprising a plurality of processing cores, a memory controller, said power management logic circuitry and said link.

10. An apparatus, comprising;
power management logic circuitry and power management program code stored on a computer readable storage medium, said power management logic circuitry and power management program code to implement a power management scheme for a link in which a prior history of said link's idle time behavior is used to determine a first estimate of said link's power consumption while idle in a higher power state and determine a second estimate of said link's power consumption while idle in a lower power state, and where said first and second estimates are used to determine an idle time for said link at which said link is transitioned to said lower power state.

11. The apparatus of claim 10 wherein said power management logic circuitry and power management program code is to analyze multiple idle time candidates at which said link is transition-able from said higher power state to a said lower power state.

12. The apparatus of claim 11 wherein the following is reveal-able from said power management logic circuitry's and power management program code's implementation of said power management scheme:
a) a first idle time when keeping said link in said higher power state is more power efficient than transitioning said link to said lower power state even though said link is idle; and,
b) a second idle time when transitioning said link from said higher power state to said lower power state is more power efficient than keeping said link in said higher power state because said prior history indicates that said idle time is expected to be sufficiently extensive.

13. The apparatus of claim 10 wherein said second estimate includes an estimate of power consumption of waking said link.

14. The apparatus of claim 10 wherein said link is a PCIe link.

15. The apparatus of claim 10 wherein said link is a component in a multi-level system memory.

16. The apparatus of claim 10 wherein said power management logic circuitry and/or power management program code includes counters, each counter of the counters to count a respective observed idle time of said prior history.

17. The apparatus of claim 10 wherein, if a comparison of said first and second estimates reveals that said link is expected to consume less power if said link remains in said higher power state than if said link were to transition to said lower power state at a first link idle time, said power management logic is to:
determine a third estimate of said link's power consumption while idle in said higher power state for a second idle time that is longer than said first idle time and determine a fourth estimate of said link's power consumption while idle in said lower power state for said second idle time.

18. The apparatus of claim 10 further comprising a computing system comprising a plurality of processing cores, a memory controller, said power management logic circuitry and power management program code and said link.

19. A computer readable storage medium containing program code that when processed by a computing system causes a method to be performed, comprising:
tracking a prior history of a link's idle time behavior;
determining a first estimate of said link's power consumption while idle in a higher power state;
determining a second estimate of said link's power consumption while idle in a lower power state; and,
using said first and second estimates to determine an idle time for said link at which said link is transitioned to said lower power state.

20. The computer readable storage medium of claim 19 further comprising analyzing multiple idle time candidates at which said link is transition-able from said higher power state to said lower power state.

21. The computer readable storage medium of claim 20 wherein said tracking further comprises maintaining counters for each of said multiple candidate idle times.

22. The computer readable storage medium of claim 19 wherein said second estimate includes an estimate of power consumption of waking said link.

23. The computer readable medium of claim 19 wherein said link is a component in a multi-level system memory.

24. The computer readable medium of claim 19 wherein said method further comprises comparing said first and second estimates and if said comparison reveals that said link is expected to consume less power if said link remains in said higher power state than if said link were to transition to said lower power state at a first link idle time, then, determining a third estimate of said link's power consumption while idle in said higher power state for a second idle time that is longer than said first idle time and determining a fourth estimate of said link's power consumption while idle in said lower power state for said second idle time.

25. A method, comprising;
tracking a prior history of a link's idle time behavior;
determining a first estimate of said link's power consumption while idle in a higher power state;
determining a second estimate of said link's power consumption while idle in a lower power state; and,
using said first and second estimates to determine an idle time for said link at which said link is transitioned to said lower power state.

26. The method of claim 25 further comprising analyzing multiple idle time candidates at which said link is transition-able from said higher power state to a said lower power state.

27. The method of claim 26 wherein said tracking further comprises maintaining counters for each of said multiple candidate idle times.

28. The method of claim 25 wherein said second estimate includes an estimate of power consumption of waking said link.

29. The method of claim 25 wherein said link is a component in a multi-level system memory.
